(19) United States
(12) Patent Application Publication
(10) Pub. No.: US 2017/0298838 A1
(43) Pub. Date: Oct. 19, 2017

(54) FUEL SUPPLY SYSTEM AND METHOD OF OPERATING A COMBUSTION TURBINE ENGINE

(71) Applicant: General Electric Company, Schenectady, NY (US)

(72) Inventors: Karthik Kothur Sathyakumar, Bangalore (IN); Karthick Kaleeswaran, Bangalore (IN); Nitin Subramanya Sarja, Bangalore (IN); Venkadesh Shanmugam, Bangalore (IN); Jayaganesh Nataraj, Coimbatore (IN)

(21) Appl. No.: 15/130,157

(22) Filed: Apr. 15, 2016

(51) Int. Cl. F02C 9/40; F02C 3/20; F02C 3/04; F02C 7/22

(52) U.S. Cl. CPC F02C 9/40; F02C 7/22; F02C 3/20; F02C 3/04; F05D 2220/32; F05D 2220/75

(57) ABSTRACT

A fuel supply system for use in a combustion turbine engine is provided. The fuel supply system includes a fuel nozzle, a source of process fuel configured to channel a flow of process fuel towards the fuel nozzle, and a source of secondary fuel configured to channel a flow of secondary fuel towards the fuel nozzle. The flow of secondary fuel mixes with the flow of process fuel to form mixed startup fuel having a higher calorific value than the process fuel, and the mixed startup fuel is discharged from the fuel nozzle during startup of the combustion turbine engine.

### BACKGROUND

The present disclosure relates generally to turbine engines and, more specifically, to systems and methods of starting a combustion turbine engine with fuel that includes process gas.

At least some known combustion turbine engines include at least one compressor, a combustor, and a turbine coupled together in a serial flow relationship. More specifically, the compressor and turbine are coupled through a shaft to form a high-pressure rotor assembly. Air entering the turbine engine is mixed with fuel and ignited to form a high energy gas stream. The high energy gas stream flows through the turbine to rotatably drive the turbine such that the shaft rotatably drives the compressor.

Many modern commercial turbine engines use process gas such as synthesis gas, coke oven gas, blast furnace gas, Corex gas, or refinery gas when operating at steady state condition. However, process gas is generally unable to be used during startup of the combustion turbine engine as a result of limitations such as flame holding velocity, for example. As such, combustion turbine engines are typically started with a startup fuel, such as natural gas and liquid fuel, and then transferred to the process gas as the combustion turbine engine approaches a steady state condition. However, incorporating startup fuel systems in known combustion turbine assemblies can add complexity and cost to the assemblies.

### BRIEF DESCRIPTION

In one aspect, a fuel supply system for use in a combustion turbine engine is provided. The fuel supply system includes a fuel nozzle, a source of process fuel configured to channel a flow of process fuel towards the fuel nozzle, and a source of secondary fuel configured to channel a flow of secondary fuel towards the fuel nozzle. The flow of secondary fuel mixes with the flow of process fuel to form mixed startup fuel having a higher calorific value than the process fuel, and the mixed startup fuel is discharged from the fuel nozzle during startup of the combustion turbine engine.

In another aspect, a fuel supply system for use in a combustion turbine engine is provided. The fuel supply system includes a fuel nozzle, a source of process fuel configured to channel a flow of process fuel towards the fuel nozzle, and a source of inert gas configured to channel a flow of inert gas towards the fuel nozzle, wherein the flow of inert gas mixes with the flow of process fuel to form mixed startup having a hydrogen content less than the process fuel, and the mixed startup fuel is discharged from the fuel nozzle during startup of the combustion turbine engine.

In yet another aspect, a combustion turbine assembly is provided. The assembly includes a combustor including at least one fuel nozzle and a fuel supply system configured to supply fuel to the combustor. The fuel supply system includes a source of process fuel configured to channel a flow of process fuel towards the at least one fuel nozzle, and a source of secondary fuel configured to channel a flow of secondary fuel towards the at least one fuel nozzle. The flow of secondary fuel mixes with the flow of process fuel to form mixed startup fuel having a higher calorific value than the process fuel, and the mixed startup fuel is discharged from the at least one fuel nozzle during startup of the combustion turbine assembly.

### BRIEF DESCRIPTION OF THE DRAWINGS

FIG. 1 is a schematic illustration of an exemplary combustion turbine assembly;

FIG. 2 is a schematic illustration of an exemplary fuel supply system that may be used with the combustion turbine assembly shown in FIG. 1; and

FIG. 3 is a schematic illustration of an alternative fuel supply system that may be used with the combustion turbine assembly shown in FIG. 1.

### DETAILED DESCRIPTION

Embodiments of the present disclosure relate to systems and methods of starting a combustion turbine engine with fuel that includes process gas. In the exemplary embodiment, high calorific value gas such as liquefied petroleum gas or liquefied natural gas are mixed with process fuel, such that the mixed process fuel meets certain combustion requirements for the combustion turbine engine (e.g., lower heating value limit). Moreover, an inert gas may be mixed with the mixed process fuel to ensure the hydrogen content of the mixed process fuel is less than a predetermined threshold. As such, the mixed process fuel can be used to start the combustion turbine engine without using startup fuel, such as natural gas or liquid fuel, thereby eliminating the equipment and cost associated with starting the combustion turbine engine with startup fuel.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

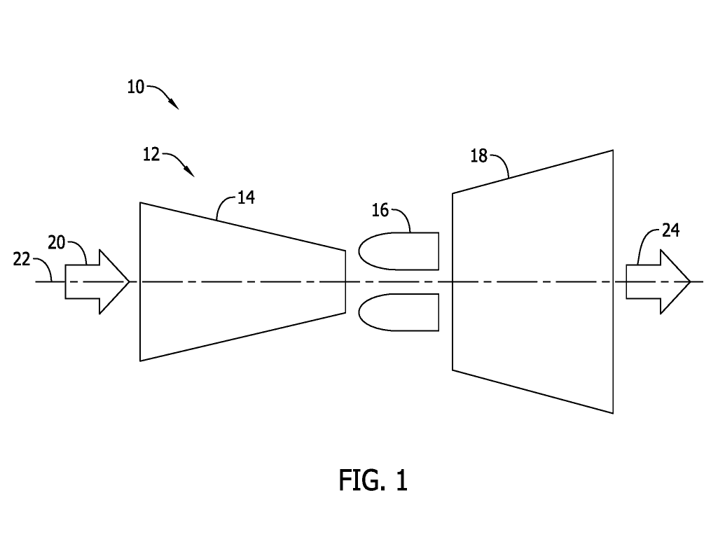

FIG. 1 is a schematic illustration of an exemplary combustion turbine assembly 10. In the exemplary embodiment, combustion turbine assembly 10 includes a combustion turbine engine 12 that includes a compressor 14, and a combustor assembly 16 positioned downstream from compressor 14. Combustion turbine engine 12 also includes a turbine 18 positioned downstream from combustor assembly 16.

In operation, a flow of intake air 20 is channeled through compressor 14 and a flow of compressed air is discharged from compressor 14 and channeled towards combustor assembly 16, where the air is mixed with fuel and combusted to form a flow of combusted gas discharged towards turbine 18. The flow of combusted gas discharged from combustor assembly 16 drives turbine 18 about a centerline 22 of combustion turbine engine 12, and the flow of combusted gas is channeled through turbine 18 and then discharged from combustion turbine engine 12 in the form of a flow of exhaust gas 24.

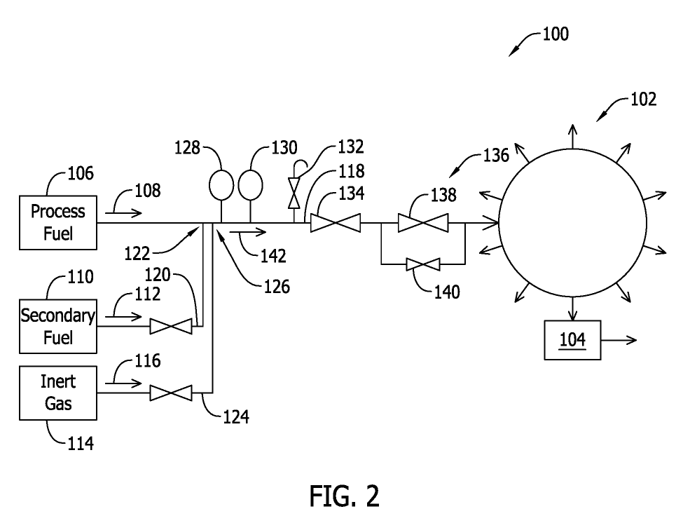

FIG. 2 is a schematic illustration of an exemplary fuel supply system 100 that may be used with combustion turbine assembly 10 (shown in FIG. 1). In the exemplary embodiment, fuel supply system 100 includes a first fuel manifold 102 that supplies fuel to at least one fuel nozzle 104 of combustor assembly 16 (shown in FIG. 1). Fuel supply system 100 also includes a source 106 of process fuel that channels a flow of process fuel 108 towards the at least one fuel nozzle 104, a source 110 of secondary fuel that channels a flow of secondary fuel 112 towards the at least one fuel nozzle 104, and a source 114 of inert gas that channels a flow of inert gas 116 towards the at least one fuel nozzle 104. Exemplary process fuels include, but are not limited to, synthesis gas, coke oven gas, blast furnace gas, Corex gas, and refinery gas. Moreover, exemplary secondary fuels include, but are not limited to, liquefied petroleum gas and liquefied natural gas. In addition, exemplary inert gases include, but are not limited to, nitrogen and carbon dioxide.

Fuel supply system 100 also includes a fuel supply line 118 that channels fuel towards the at least one fuel nozzle 104, a secondary fuel line 120 coupled along fuel supply line 118 at a first injection site 122, and an inert gas line 124 coupled along fuel supply line 118 at a second injection site 126. A calorimeter 128 and a gas analyzer 130 are coupled along fuel supply line 118. Calorimeter 128 is positioned to determine a lower heating value of the flow of process fuel 108, and gas analyzer 130 is positioned to determine a hydrogen content of the flow process fuel 108. More specifically, calorimeter 128 and gas analyzer 130 are positioned downstream from first injection site 122 and second injection site 126. As such, as will be explained in more detail below, calorimeter 128 and gas analyzer 130 are positioned to enable the lower heating lower calorific value and the hydrogen content of process fuel 108 to be dynamically determined and modified by injection of secondary fuel 112 and inert gas 116 at first injection site 122 and second injection site 126.

Fuel supply system 100 further includes a vent valve 132, a stop valve 134, and control valve assembly 136 positioned between sources 106, 110, and 114 and first fuel manifold 102. Stop valve 134 selectively actuates to control the flow of fuel channeled towards first fuel manifold 102, and vent valve 132 vents fuel remaining in fuel supply line 118 when stop valve 134 is in a closed position. Moreover, control valve assembly 136 includes a process fuel control valve 138 and a startup fuel control valve 140 coupled in parallel with process fuel control valve 138 along fuel supply line 118. Startup fuel control valve 140 is sized to allow a smaller flow of fuel to be channeled towards the at least one fuel nozzle 104 than process fuel control valve 138 to facilitate proper startup of combustion turbine assembly 10. As will be described in more detail below, process fuel control valve 138 and startup fuel control valve 140 are selectively operable based on an operating condition of combustion turbine assembly 10, and based on the type of fuel to be channeled towards the at least one fuel nozzle 104.

In operation, source 106 of process fuel channels the flow of process fuel 108 towards the at least one fuel nozzle 104, and source 110 of secondary fuel channels the flow of secondary fuel 112 towards the at least one fuel nozzle 104 such that the flow of secondary fuel 112 mixed with the flow of process fuel 108 to form mixed startup fuel 142 having a higher calorific value than process fuel 108. Increasing the calorific value of process fuel 108 enables a mixture including process fuel 108 to be used during startup of combustion turbine assembly 10. As shown in FIG. 2, mixed startup fuel 142 is formed in fuel supply line 118 upstream of the at least one fuel nozzle 104. As such, mixed startup fuel 142 is channeled towards the at least one fuel nozzle 104 and discharged from the at least one fuel nozzle 104 during startup of combustion turbine assembly 10, and only process fuel 108 is channeled towards the at least one fuel nozzle 104 as combustion turbine assembly 10 approaches a steady state operating condition.

More specifically, control valve assembly 136 is selectively operable based on the operating condition of combustion turbine assembly 10. For example, process fuel control valve 138 is actuated into a closed position and startup fuel control valve 140 is actuated into an open position during startup of combustion turbine assembly 10 such that mixed startup fuel 142 is channeled towards the at least one fuel nozzle 104. Process fuel control valve 138 is actuated into an open position and startup fuel control valve 140 is actuated into an open/closed position as combustion turbine assembly 10 approaches a steady state operating condition such that only process fuel 108 is channeled towards the at least one fuel nozzle 104. Process fuel control valve 138 and startup fuel control valve 140 may also be actuated into an intermediate position between an open position and a closed position.

In some embodiments, source 114 of inert gas channels the flow of inert gas 116 towards the at least one fuel nozzle such that the flow of inert gas 116 mixes with the flow of process fuel 108 to form mixed startup fuel 142 having a hydrogen content less than process fuel 108. More specifically, gas analyzer 130 determines the hydrogen content of process fuel 108, and inert gas 116 is mixed with process fuel 108 when it is determined that the hydrogen content level of process fuel 108 greater than a predetermined threshold and at an unsafe level. As such, source 114 of inert gas selectively channels the flow of inert gas 116 towards the at least one fuel nozzle at a flow rate such that the hydrogen content of mixed startup fuel 142 is at a safe volumetric percent of the mixed startup fuel. In one embodiment, the hydrogen content is less than about 5 percent by volume of the mixed startup fuel.

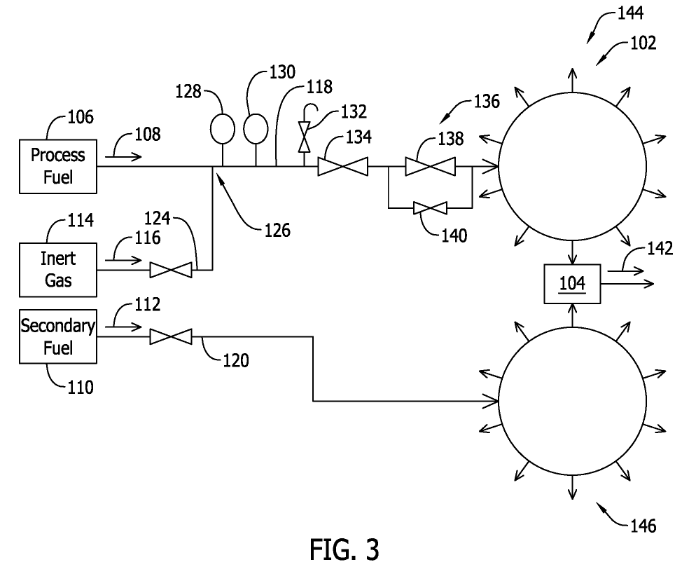

FIG. 3 is a schematic illustration of an alternative fuel supply system 144 that may be used with combustion turbine assembly 10 (shown in FIG. 1). In the exemplary embodiment, fuel supply system 144 includes a second fuel manifold 146 coupled in flow communication with source 110 of secondary fuel. The at least one fuel nozzle 104 receives the flow of process fuel 108 from source 106 via first fuel manifold 102, and receives the flow of secondary fuel 112 from source 110 via second manifold 146. More specifically, the flow of process fuel 108 and the flow of secondary fuel 112 is channeled through respective passages (not shown) within the at least one fuel nozzle 104 and mixed within a mixing zone therein such that mixed startup fuel 142 is formed within fuel nozzle 104. As such, a more concentrated and smaller amount of secondary fuel 112 can be used to increase the calorific value of process fuel 108 when forming mixed startup fuel 142.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel supply system for use in a combustion turbine engine, said fuel supply system comprising:
a fuel nozzle;
a source of process fuel configured to channel a flow of process fuel towards said fuel nozzle; and
a source of secondary fuel configured to channel a flow of secondary fuel towards said fuel nozzle, wherein the flow of secondary fuel mixes with the flow of process fuel to form mixed startup fuel having a higher calorific value than the process fuel, and wherein the mixed startup fuel is discharged from said fuel nozzle during startup of the combustion turbine engine.

2. The system in accordance with claim 1 further comprising a fuel supply line configured to channel the mixed startup fuel towards said fuel nozzle, wherein the mixed startup fuel is formed in said fuel supply line upstream of said fuel nozzle.

3. The system in accordance with claim 2 further comprising a control valve assembly coupled along said fuel supply line, said control valve assembly comprising:
a process fuel control valve; and
a startup fuel control valve coupled in parallel with said process fuel control valve along said fuel supply line, wherein said process fuel control valve and said startup fuel control valve are selectively operable based on an operating condition of the combustion turbine engine.

4. The system in accordance with claim 1, wherein said fuel nozzle is configured to receive the flow of process fuel and the flow of secondary fuel such that the mixed startup fuel is formed within said fuel nozzle.

5. The system in accordance with claim 1 further comprising a source of inert gas configured to channel a flow of inert gas towards said fuel nozzle, wherein the flow of inert gas mixes with the flow of process fuel to form the mixed startup fuel having a hydrogen content less than the process fuel.

6. The system in accordance with claim 5, wherein said source of inert gas is configured to channel the flow of inert gas towards said fuel nozzle at a flow rate such that the hydrogen content is less than about 5 percent by volume of the mixed startup fuel.

7. The system in accordance with claim 1, wherein said source of secondary fuel is configured to channel at least one of a flow of liquefied petroleum gas or a flow of liquefied natural gas towards said fuel nozzle.

8. A fuel supply system for use in a combustion turbine engine, said fuel supply system comprising:
a fuel nozzle;
a source of process fuel configured to channel a flow of process fuel towards said fuel nozzle; and
a source of inert gas configured to channel a flow of inert gas towards said fuel nozzle, wherein the flow of inert gas mixes with the flow of process fuel to form mixed startup having a hydrogen content less than the process fuel, and wherein the mixed startup fuel is discharged from said fuel nozzle during startup of the combustion turbine engine.

9. The system in accordance with claim 8, wherein said source of inert gas is configured to channel the flow of inert gas towards said fuel nozzle at a flow rate such that the hydrogen content is less than about 5 percent by volume of the mixed startup fuel.

10. The system in accordance with claim 8, wherein said source of inert gas is configured to channel the flow of inert gas towards said fuel nozzle at a flow rate such that the mixed startup fuel has a lower calorific value than the process fuel.

11. The system in accordance with claim 8 further comprising a fuel supply line configured to channel the mixed startup fuel towards said fuel nozzle, wherein the mixed startup fuel is formed in said fuel supply line upstream of said fuel nozzle.

12. The system in accordance with claim 11 further comprising a control valve assembly coupled along said fuel supply line, said control valve assembly comprising:
a process fuel control valve; and
a startup fuel control valve coupled in parallel with said process fuel control valve along said fuel supply line, wherein said process fuel control valve and said startup fuel control valve are selectively operable based on an operating condition of the combustion turbine engine.

13. The system in accordance with claim 8, wherein said fuel nozzle is configured to receive the flow of process fuel and the flow of inert gas such that the mixed startup fuel is formed within said fuel nozzle.

14. The system in accordance with claim 8, wherein said source of inert gas is configured to channel at least one of a flow of nitrogen gas or a flow of carbon dioxide towards said fuel nozzle.

15. A combustion turbine assembly comprising:
a combustor comprising at least one fuel nozzle; and
a fuel supply system configured to supply fuel to said combustor, said fuel supply system comprising:
a source of process fuel configured to channel a flow of process fuel towards said at least one fuel nozzle; and
a source of secondary fuel configured to channel a flow of secondary fuel towards said at least one fuel nozzle, wherein the flow of secondary fuel mixes with the flow of process fuel to form mixed startup fuel having a higher calorific value than the process fuel, and wherein the mixed startup fuel is discharged from said at least one fuel nozzle during startup of the combustion turbine assembly.

16. The assembly in accordance with claim 15, wherein said at least one fuel nozzle is configured to receive the flow of process fuel and the flow of secondary fuel such that the mixed startup fuel is formed within said at least one fuel nozzle.

17. The assembly in accordance with claim 15 further comprising a fuel supply line configured to channel the mixed startup fuel towards said at least one fuel nozzle, wherein the mixed startup fuel is formed in said fuel supply line upstream of said at least one fuel nozzle.

18. The assembly in accordance with claim 17 further comprising a control valve assembly coupled along said fuel supply line, said control valve assembly comprising:
a process fuel control valve; and
a startup fuel control valve coupled in parallel with said process fuel control valve along said fuel supply line, wherein said process fuel control valve and said startup fuel control valve are selectively operable based on an operating condition of the combustion turbine assembly.

19. The assembly in accordance with claim 15 further comprising a source of inert gas configured to channel a flow of inert gas towards said at least one fuel nozzle, wherein the flow of inert gas mixes with the flow of process fuel to form the mixed startup fuel having a hydrogen content less than the process fuel.

20. The assembly in accordance with claim 19, wherein said source of inert gas is configured to channel the flow of inert gas towards said at least one fuel nozzle at a flow rate such that the hydrogen content is less than about 5 percent by volume of the mixed startup fuel.
